(19) United States
(12) Patent Application Publication
(10) Pub. No.: US 2009/0077094 A1
(43) Pub. Date: Mar. 19, 2009

(54) Method and system for ontology modeling based on the exchange of annotations

(75) Inventor: Yan Bodain, Montreal (CA)

Correspondence Address: Yan Bodain, 2930-403 Edouard Montpetit, Montreal, QC, H3T 1J7, CA

(73) Assignee: Yan Bodain, Montreal (CA)

(21) Appl. No.: 11/898,814

(22) Filed: Sep. 17, 2007

(51) Int. Cl. G06F 17/30

(52) U.S. Cl. 707/10; 707/E17.009

(57) ABSTRACT

The present invention is based on the use of annotation. An annotation is an information that can be applied to a content to provide extra information.

The present invention provides for a method and system to use an annotation being imported into a document to replicate the ontology related to this annotation and to exploits this replication to create indirect links between different ontologies elements. The indirect links between the different ontologies constitute by themselves a global ontology that can be used by search engines to locate web contents in the Semantic Web.

### CROSS-REFERENCE TO RELATED APPLICATIONS

There are no cross-related applications.

### STATEMENT REGARDING FEDERALLY SPONSORED RESEARCH OR DEVELOPMENT

Not applicable.

### BACKGROUND OF THE INVENTION

1. Field of Invention

The invention relates to a system and method for building up ontology, marking, organizing, and searching Web-based contents. More specifically, the invention relates to the utilization of annotation and ontology to semantically classify data.

2. References Cited
DARPA Agent Markup Language (DAML), http://www.daml.org
Hypertext Markup Language 2.0, RFC 1866, http://www.faqs.org/rfcs/rfc1866.html
OWL Web Ontology Language (OWL), http://www.w3.org/TR/owl-features/
Resource Description Framework (RDF), http://www.w3.org/RDF
Standard Generalized Markup Language, ISO 8879:1986, http://www.iso.org
URN Syntax, RFC 2141, http://tools.ietf.org/html/rfc2141
XML Media Types, RFC 3023, http://www.faqs.org/rfcs/rfc3023.html

3. Description of Related Art

The Internet is a global network of connected computer networks. Over the last several years, the Internet has grown in significant measure. A large number of computers in the Internet provide information in various forms. Anyone with a computer connected to the Internet can potentially tap into this vast pool of information.

The most wide spread method of providing information over the Internet is via the World Wide Web (the Web). The Web consists of a subset of the computers connected to the Internet; the computers in this subset run Hypertext Transfer Protocol (HTTP) servers (Web servers). The information available via the Internet also encompasses information available via other types of information servers such as FTP and email (POP, IMAP).

Information in the Internet can be accessed through the use of a Uniform Resource Identifier (URI). A URI is a compact string of characters used to identify or name a resource in the Internet. A URI can be classified as a name (URN) or a locator (URL). A URN (Uniform Resource Name) is a URI that uses the urn scheme, and does not imply availability of the identified resource. The urn scheme is described in the RFC 1737 (http://tools.ietf.org/html/rfc1737). A URL (Uniform Resource Locator) is a URI that uniquely specifies the location of a particular piece of information in the Internet. A URL is typically composed of several components. The first component designates the protocol by witch the address piece of information is accessed (e.g., HTTP, FTP, MAILTO, etc.). This first component is separated from the remainder of the URL by a colon (“:”). The remainder of the URL will depend upon the protocol. Typically, the remainder designates a computer in the Internet by name, or by IP number, as well as a more specific designation of the location of the resource on the designated computer. For instance, a typical URL for an HTTP resource might be “http://www.ibm.com/dir/page.html” where “http” is the protocol, “www.ibm.com” is the designated computer, “dir” is the directory and “page.html” identified the location of the resource on the designated directory.

Web servers host information in the form of Web pages; collectively the server and the information hosted are referred to as a Web site. A significant number of Web pages are encoded using the Hypertext Markup Language (HTML) although other encodings using the eXtensible Markup Language (XML) are becoming increasingly more common. The published specifications for these languages are incorporated by reference herein. Web pages in these formatting languages may include links to other Web pages in the same Web site or another. As known to those skilled in the art, Web pages may be generated dynamically by a server by integrating a variety of elements into a formatted page prior to transmission to a Web client. Web servers and information servers of other types await requests for the information that they receive from Internet clients.

Advanced clients such as FireFox and Microsoft Internet Explorer allow users to access data provided via a variety of information servers in a unified client environment. Typically, such client software is referred to as browser software.

The Web has been organized using syntactic and structural methods and apparatus. Consequently, most major applications such as search, personalization, advertisements, and e-commerce, utilize syntactic and structural methods and apparatus. Directory services, such as those offered by Yahoo! and Looksmart, offer a limited form of semantics by organizing content by category or subjects, but the use of context and domain semantics is minimal. When semantics is applied, critical work is done by humans (also termed editors or catalogers), and very limited, if any, domain specific information is captured.

Current search engines rely on syntactic and structural methods. The use of keyword and corresponding search techniques that utilize indices and textual information without associated context or semantic information is an example of such a syntactic method. Use of these syntactic methods in information retrieval using keyword-based search is the most common way of searching today. Unfortunately, most search engines produce up to hundreds of thousands of results, and most of them bear little resemblance to what the user was originally looking for, mainly because the search context is not specified and ambiguities are hard to resolve. One way of enhancing a search request is using Boolean and other operators like “+/−” or “NEAR” whereby the number of resulting pages can be drastically cut down. However, the results still may bear little resemblance to what user is looking for.

Most search engines and Web directories offer advanced searching techniques to reduce the amount of results (recall) and improve the quality of the results (precision). Some search methods utilize structural information, including the location of a word or text within a document or site, the numbers of times users choose to view a specific results associated with a word, the number of links to a page or a site, and whether the text can be associated with a tag or attributes (such as title, media type, time) that are independent of subject matter or domain. In a few cases when domain specific attributes are supported (as in the genre of music), the search is limited to one domain or one site (i.e. Amazon.com). It may also be limited to one purpose, such as product price comparison.

Grouping search results by Web sites, as some search engines like Excite offer, can make it easier to browse through the often vast number of results. NorthernLight takes the idea of organizing the Web one step further by providing a way of organizing search results into so-called “buckets” of related information (such as “Thanksgiving”, “Middle East” & “Turkey”, . . . ). Both approaches do not improve the search quality per se, but they facilitate the navigation through the search results.

Directory services support browsing and a combination of browsing with a limited set of attributes for the content managed or aggregated by the site. When domain information is captured, a host of people (over 1000 at one company providing directing services and over 200 at another) classifies new and old Web pages, to ensure the quality of those domain search results. This is an extremely human-intensive process. The human catalogers or editors use hundreds of classification or keyword terms that are mostly proprietary to that company. Considering the size and growth rate of the World Wide Web, it seems almost impossible to index a “reasonable” percentage of the available information by hand. While Web crawlers can reach and scan documents in the farthest locations, the classification of structurally very different documents has been the main obstacle of building a metabase that allows the desired comprehensive attribute search against heterogeneous data.

The context of a search request is necessary to resolve ambiguities in the search terms that the user enters. For instance, a digital media search for “windows instructions” in the context of “computer technology” should find audio/video files about how to use windowing operation systems in general or Microsoft Windows in particular. However, the same search in the context of “home and garden” is expected to lead to instructional videos about how to mount window in your own home.

Due to the unstructured and heterogeneous nature of the Web resources, every Web site uses a different terminology to describe similar things. A semantic mapping of terms is then necessary to ensure that the system serves documents within the same context in which the user searched.

Current manual or automated content acquisition may use metatags that are part of an HTML page, but these are proprietary and have no contextual meaning for general search applications.

Research in heterogeneous database management and information systems have addressed the issues of syntax, structure and semantics, and have developed techniques to integrate data from multiple databases and data sources. Large scale scaling and associated automation has, however, not be achieved in the past. One key issue in supporting semantics is that of understanding and modeling context.

Semantics can be directly incorporated into document by using Resource Description Framework (RDF). RDF was originally designed as a metadata model but has come to be used as a general method of modeling information, through a variety of different syntax formats. RDF has been developed by the World Wide Web Consortium and more information is available in the Internet at http://www.w3.org/RDF/.

The RDF metadata model is based upon the idea of making statements about resources in the form of subject-predicate-object expressions, called triples in RDF terminology. The subject denotes the resource, while the predicate denotes traits or aspects of the resource and expresses a relationship between the subject and the object. For example, one way to represent the notion “The sky has the color blue” in RDF is as a triple of specially formatted strings: a subject denoting “sky”, a predicate denoting “hasColor”, and an object denoting “blue”. Thus, RDF can be used to make semantic descriptions of Web resource. However, RDF does not contain any ontological model.

The product of an attempt to formulate an exhaustive and rigorous conceptual schema about a domain is described as “ontology”. An ontology is typically a hierarchical data structure containing all the relevant entities and their relationships and rules within that domain (eg. a domain ontology). Basic concepts of ontology include 1) classes of instances/things, 2) properties, 3) relations between the classes.

Prior art ontology systems include the DARPA Agent Markup Language (DAML) witch is also based on RDF. DAML includes hierarchical relations, and a meta-level formally describing features of an ontology, such as author, name and subject. DAML includes a class of ontologies for describing its own ontologies. It also includes a formal syntax for relations used to express ranges, domains and cardinality restrictions on domains and co-domains. Information about DAML is available in the Internet at http://www.daml.org.

Prior art ontology systems also include OWL (Web Ontology Language) witch reuses the definition of DAML by adding a vocabulary for describing properties and classes: among others, relations between classes (e.g. disjointness), cardinality (e.g. “exactly one”), equality, richer typing of properties, characteristics of properties (e.g. symmetry), and enumerated classes. Information about OWL is available in the Internet at http://www.w3.org/TR/owl-features/.

In summary, RDF can be used to describe Web contents while OWL can be used to express ontological concepts. The use of RDF and OWL is, however, problematic because there is no widespread adoption of these standards for page and site creators. These standards must be used before appropriate agents can be written. Even then, existing content cannot be indexed, cataloged, or extracted to make it a part of what is called a “Semantic Web”.

The concept of a Semantic Web is an important step forward in supporting higher precision, relevance and timeliness in using Web-accessible content. The Semantic Web provides a common framework that allows data to be shared and reused across application, enterprise, and community boundaries. It is a collaborative effort led by W3C with participation from a large number of researchers and industrial partners. Information about the Semantic Web is available in the Internet at http://www.w3.org/2001/sw/.

Currently, syntax and structure-based methods pervade the entire Web (both in its creation and the applications realized over it). The challenge has been to include semantic descriptions while creating content as required by current proposals for the Semantic Web. These semantic descriptions should refer to ontologies in order to define the precise meaning of Web contents. Because many different ontologies can be use to describe the same thing, it is actually very important to develop a means to facilitate the alignment of equivalent concept coming from different ontologies. The present invention relates to a method and system for a collaborative ontology modeling based on the exchange of annotations and their use for the semantic descriptions of Web contents.

### SUMMARY OF THE INVENTION

The present invention is directed to software, a system and a method for collaborative ontology modeling based on the exchange of annotations between actors (users, software agent, application, etc.) over the Internet.

An annotation is an information that can be applied to a content to provide extra information. The content can be a variety of digital media content, semi-structured text, data sets, audio, video, animations, including TV and radio content potentially delivered on Internet. The present invention provides for a method and system to use an annotation being imported into a document to replicate the ontology related to this annotation and to exploits this replication to create indirect links between the different ontologies elements. The indirect links between different ontologies constitute by themselves a global ontology that can be used by search engines to locate web contents in the Semantic Web.

The present invention includes the ability to create a correspondence, or mapping, between an ontology and a Web content. Preferably, the mapping identifies certain ontology elements with certain contents in one or many different documents.

The present invention provides for a method to construct ontologies in a bottom-up approach, by letting individual actor to create ontology classes without requiring the need of a well organize team of knowledge engineers.

The present invention also includes the ability to develop a consensus in the ontology definition by letting every actor to decide by itself of the use or rejection of the imported ontology element in its own document and to participate this way to the construction of a common structure of ontology (ontology alignment).

The present invention provides for a distributed ontology, built up from individual ontology efforts distributed over the Internet, which in aggregate comprise a global ontology that can be used to locate content. The physical distribution of different parts of the ontology is arbitrary, and the different parts may reside on the same physical computer or on different physical computers.

A feature of the present invention is the ability to update ontology and its different copies, by controlling changes made to an ontology so as to ensure backward compatibility. This ensures that a vocabulary that is valid within the framework of a current ontology will continue to be valid with respect to the framework of others ontology that also use the same element. Thus an ontology may be updated and yet maintain backward compatibility by adding new classes and relations, by adding superclass/subclass inheritance relations, and by extending existing relations and functions. In accordance with a preferred embodiment of the present invention, the update feature enables enrichment of an ontology without disrupting previous definition of the ontology.

The present invention includes a novel user interface for making and sharing annotation. The present invention also includes a novel user interface for retrieving ontologies (including interrelated classes, relations, functions and instances of classes) related to annotated contents. Preferably, the user interface of the present invention uses labels and icons to represent ontology classes. The user can navigate iteratively from one ontology to another using an icon representing external ontologies inside a tree like structure.

The present invention includes a novel method to produce a description of a Web site by deriving an index of the available contents from an ontology. A preferred embodiment of the present invention includes an index created in a machine processable format (RDF, OWL, etc.) as well as human consumable format (HTML, text, etc.).

The semantic descriptions generated by the present invention forms the basis for implementing a Semantic Web as well as for developing methods to support applications for the Semantic Web, including semantic search, semantic profiling and semantic advertisement. For example, semantics descriptions may be exchanged and utilized between partners, including content owner (or content syndicates or distributor), destination sites (or the sites visited by users), and advertisers (or advertisement distributors or syndicates), to improve the value of content ownership, advertisement space (impressions), and advertisement charges.

The present invention also includes the ability to create a community of practice by exploiting the indirect links created between ontologies to find users who share the same common interest.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DESCRIPTION OF THE DRAWINGS

The accompanying drawings, which are incorporated in and constitute a part of this specification, illustrate one embodiment of the invention and together with the description, serve to explain the principles of the invention.

FIG. 1 is a bloc diagram depicting the internal structure of a programmable processing system.

FIG. 2 is a diagram of an operating environment according to an exemplary embodiment of the present invention.

FIG. 3 is a block diagram of a RDF repository according to an exemplary embodiment of the present invention.

FIG. 4 illustrates an example of RDF triples stored inside a database.

FIG. 5 illustrates an example of an OWL ontology.

FIGS. 6-7-8 graphically depict the process of enhancing a document with an annotation in order to retrieve the corresponding ontology.

FIG. 9 illustrates the RDF model before the exchange of annotations.

FIG. 10 illustrates the resulting RDF model after the exchange of annotations.

FIG. 11-12 present a preferred embodiment for the graphics user interface.

FIG. 13 presents a preferred embodiment for HTML page output.

FIG. 14 illustrates a preferred embodiment for the RDF description file created to describe the Web pages.

FIG. 15 illustrates a preferred embodiment for HTML index created to resume the entire web site.

FIG. 16 illustrates the architecture of the preferred embodiment of the present invention.

FIG. 17 resumes graphically the process of using annotations as means of ontology modeling.

### DETAILED DESCRIPTION OF THE PREFERRED EMBODIMENT

A preferred embodiment of the invention is now described in detail. Referring to the drawings, like numbers indicate like parts throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. In the foregoing discussion, the following terms will have the following definitions unless the context clearly dictates otherwise.
Actors: something or someone who supplies a stimulus to the system. For example: user, software agent, application, etc.
Agent: a piece of software that acts for a user or other program in a relationship of agency. Such “action on behalf of” implies the authority to decide when (and if) action is appropriate. The idea is that agents are not strictly invoked for a task, but activate themselves. Related and derived concepts include intelligent agents (in particular exhibiting some aspect of Artificial Intelligence, such as learning and reasoning), autonomous agents (capable of modifying the way in which they achieve their objectives), distributed agents (being executed on physically distinct machines), multi-agent systems (distributed agents that do not have the capabilities to achieve an objective alone and thus must communicate), and mobile agents (agents that can relocate their execution onto different processors).
Annotation: information that can be applied to a content to provide extra information. For example, a text can be associated to an ontology class with an annotation.
Class: a set of real world entities whose elements have a common classification; e.g., a class called Book is the set of all books in existence.
Content or Media Content: data, data sets, text, semi-structured text, image, audio, video, animations, including TV and radio content potentially delivered on Internet.
Database: a collection of tables, each having one or more fields, in which fields of a table may themselves point to other tables.
Domain: a comprehensive modeling of information (including digital media and all data or information such as those accessible in the Web) with the broadest variety of metadata possible.
Inheritance: the binary relationship on the set of all classes, of one class being a subclass of another class.
Instance: an element of a class; e.g., “Gone with the Wind” is an instance of Book.
Metadata: a type of data describing other data. Or, as it is often put, metadata is data about data.
Ontology: a universe of subjects or terms (also, categories and attributes) and relationships between them, often organized in a hierarchical structure; includes a commitment to uniformly use the terms in a discourse in which the ontology is subscribed to or used.
OWL: (Web Ontology Language), a specification developed by the W3C for making ontological statements. OWL is developed as a vocabulary extension of RDF.
RDF: (Resource Description Framework), a specification developed by the W3C for representing resources in the Web. RDF is a directed, labeled graph data format. It allows the description of Web resources by using “triple” (subject-predicate-object) statement. RDF can be expressed in XML as well as other formats (Turtle, Notation 3, etc.).
Repository: a central place where data is stored and maintained. A repository can be a place where multiple databases, files, records or data are located for distribution. A repository could possibly be created without a socket or a network connection. For example, a repository could simply be a location in the memory of a computer for supporting a program execution.
Search result or hits: a listing of results provided by a state-of-the-art search engine, typically consisting of a title, a very short (usually 2 lines) description of a document or Web page, and an URL for the Web page or document.
Semantic advertising: utilizing semantics to target advertising to users (utilizing semantic-based information such as that available from semantic search or semantic profiling). It is also an application of the Semantic Web.
Semantic browsing and querying: a method of combining browsing and querying to specify search for information that also utilizes semantics, especially the domain context provided by browsing and presenting relevant domain specific attributes to specifying queries. It is also an application of the Semantic Web.
Semantic profiling: capture and management of user interests and usage patterns utilizing the semantics-based organization. It is also an application of the Semantic Web.
Semantic search: allowing users to use semantics, including domain specific attributes, in formulating and specifying search and utilizing context and other semantic information in processing search request. It is also an application of the Semantic Web.
Semantic Web: concept that Web-accessible content can be organized semantically, rather than though syntactic and structural methods. It is also an application of the Semantic Web.
Semantics: implies meaning and use of data, relevant information that is typically needed for decision making. Domain modeling (including directory structure, classification and categorizations that organize information), ontologies that represent relationships and associations between related terms, context and knowledge are important components of representing and reasoning about semantics. Analysis of syntax and structure can also lead to semantics, but only partially. Since the term semantics has been used in many different ways, its use herein is directed to those cases that at the minimum involve domain-specific information or context.
Socket: A socket is one endpoint of a two-way communication link between two programs running on the network. A socket is bound to a port number so that the TCP layer can identify the application that data is destined to be sent.
SPARQL: (SPARQL Protocol and RDF Query Language), defines the syntax and semantics to express queries across diverse data sources, whether the data is stored natively as RDF or viewed as RDF via middleware. SPARQL contains capabilities for querying required and optional graph patterns along with their conjunctions and disjunctions. The results of SPARQL queries can be results sets or RDF graphs.
Structure: implies the representation or organization of data and information.
Subclass: a class that is a subset of another class; e.g., a class called “Sherlock Holmes Novels” is a subclass of a class called Book.
Superclass: a class that is a superset of another class; e.g., a class called Book is a superclass of a class called “Sherlock Holmes Novels”.
Syntax: use of words, without the associated meaning or use.
XML: (eXtensible Markup Language), a specification developed by the W3C that allows for the creation of customized tags similar to those in HTML. The standard allows definition, transmission, validation, and interpretation of data between applications and between organizations.

The invention may be implemented in hardware or software, or a combination of both. Preferably, the invention is implemented in a software program executing on a programmable processing system comprising a processor, a data storage system, an input device, and an output device.

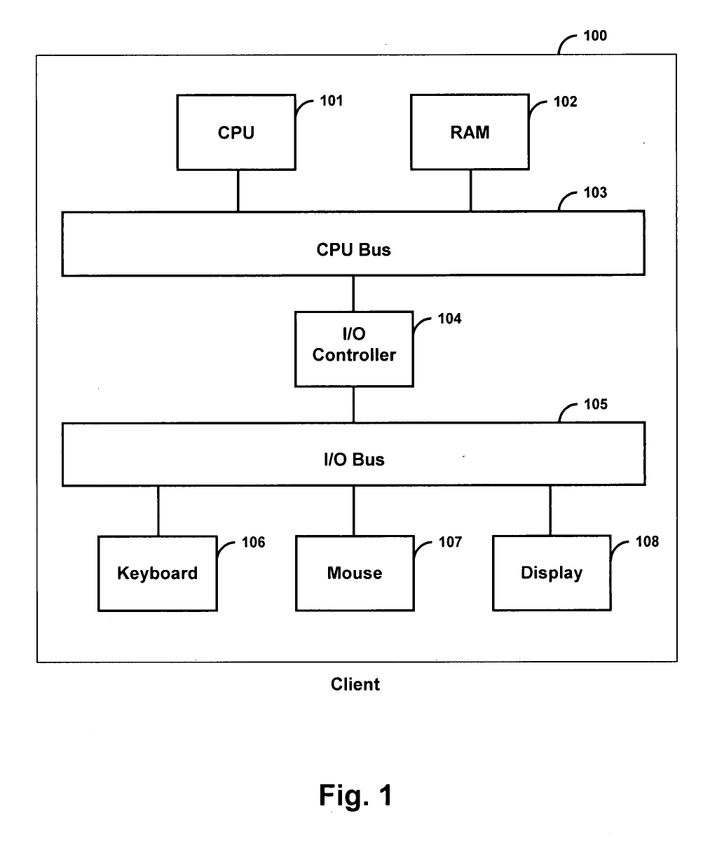

FIG. 1 illustrates one such programmable processing system 100, including a CPU 101, a RAM 102, and an I/O controller 104 coupled by a CPU bus 103. The I/O controller 104 is also coupled by an I/O bus 105 to input devices such as a keyboard 106 and mouse 107, and output devices such as a display 108.

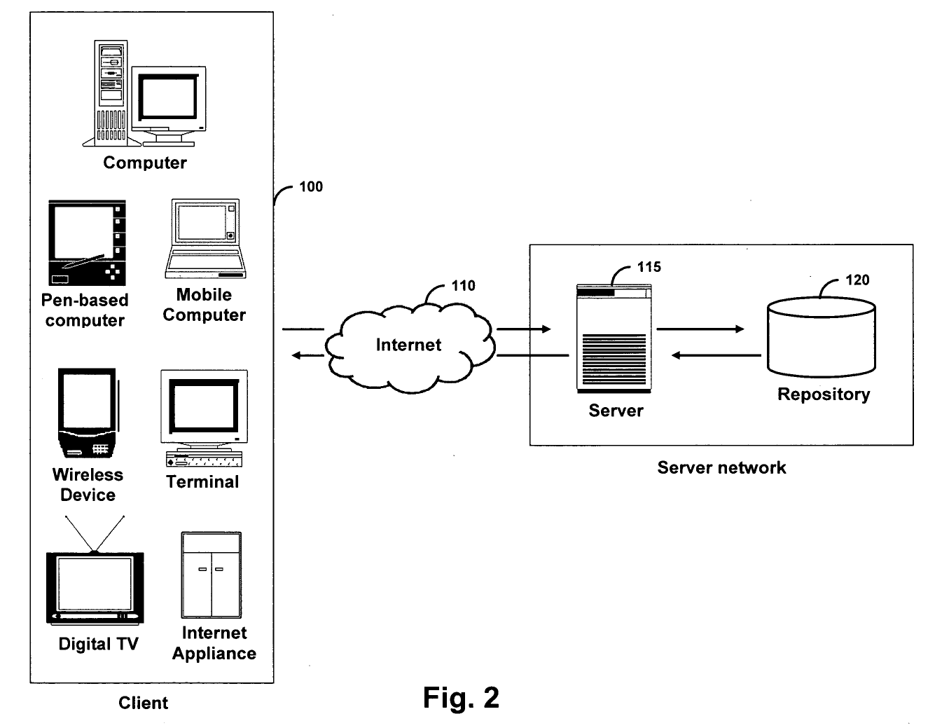

FIG. 2 is a block diagram depicting a network architecture that facilitates the storing, searching and transfer of annotation in accordance with an exemplary embodiment of the present invention. According to one embodiment, an annotation can be made by a programmable client system 100 like a computer, a pen-based computer, a mobile computer, a wireless device, a terminal, a digital TV of any other Internet appliance and be exchanged over the Internet 110 by a network link that may include telephone lines, DSL, cable networks, T1 lines, ATM/SONNET, wireless network, or any arrangement that allows for the transmission and reception of network signals. In an exemplary embodiment, the annotation repository is composed of a Web server 115 connected to a database or a structured file 120. Other embodiment is also possible and the repository can be placed in a location that is directly accessible without using a network or a socket connection. The web server includes processors and memory for executing program instructions as well network interfaces. Database could also comprise, among other components, a user information database.

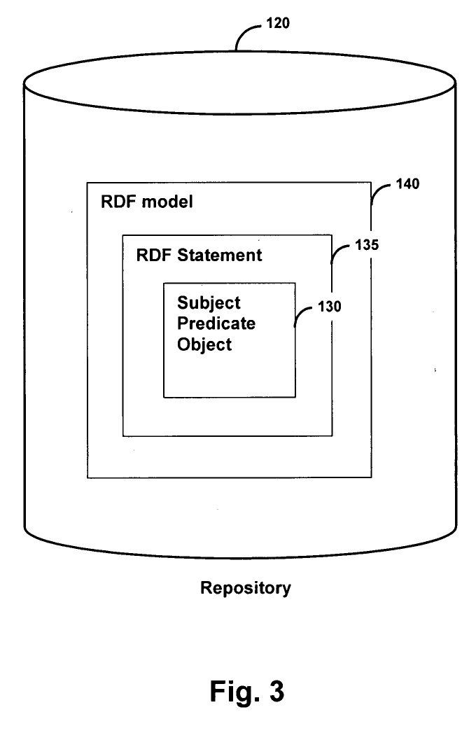

FIG. 3 is a block diagram of a repository structure 120 according to the present invention. The repository is composed of one or more RDF models 140 witches are made of one or many RDF statements 135. Each RDF statement is composed by a triple made by a subject, a predicate and an object 130. Those skilled in the art realize that RDF repository may be represented in many different ways, such as individual tables in one or more relational databases.

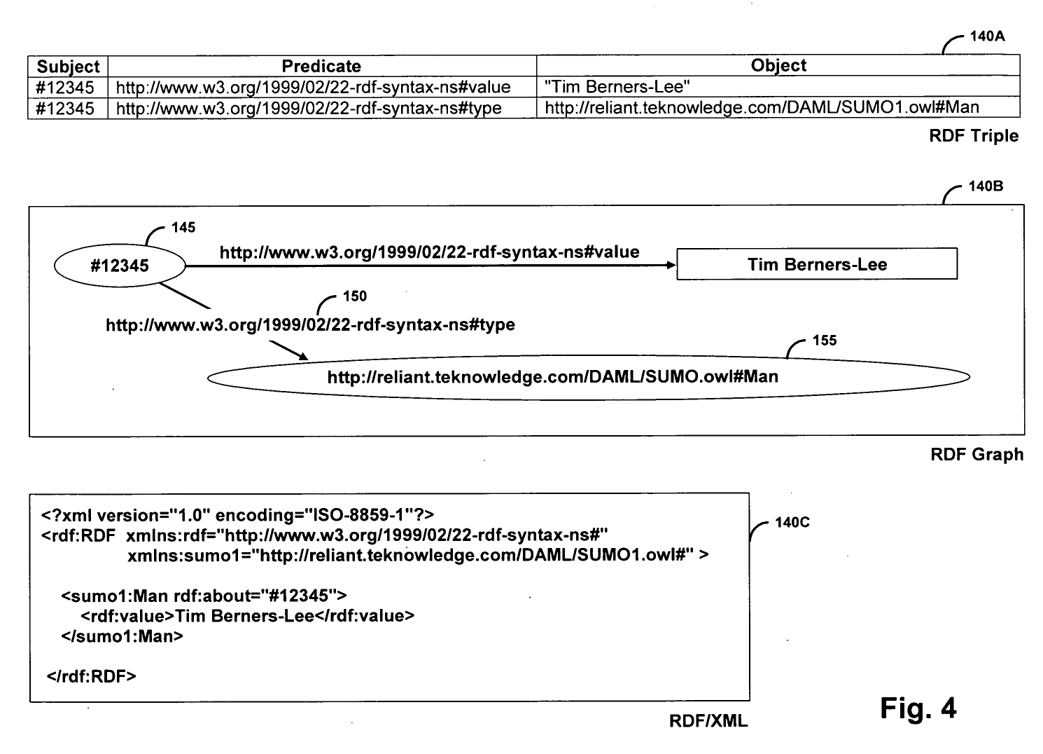

FIG. 4 illustrates an example of RDF triples stored inside a database. A RDF triple is made by a subject, a predicate and an object stored in 3 different data fields 140A. RDF triples can also be expressed as a graph 140B. For example, a resource 145 (subject) can have a relation 150 (predicate) to another resource 155 (object) in order to expressed that “#12345” is a “type” of “Man”. RDF triples can also be expressed in a XML syntax 140C stored inside a flat file or inside one or more relational databases. A RDF expression can refer to an ontology class 155 residing inside or outside the current repository boundaries. For example, the value “http://reliant.teknowledge.com/DAML/SUMO.owl#Man” represents an absolute URL to a fragment named “Man”. This fragment is a class residing on a server located at “http://reliant.teknowledge.com” inside the “DAML” directory in a file named “SUMO.owl”.

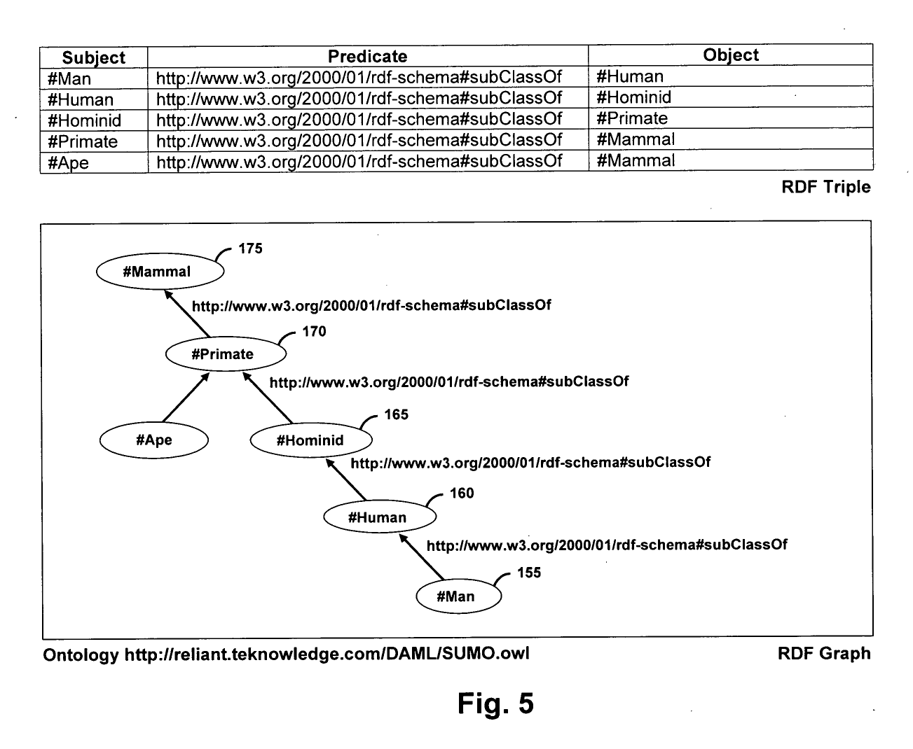

FIG. 5 illustrates an example of the corresponding OWL ontology. The class “Man” 155 is a subclass of “Human” 160, witch is also a subclass of “Hominid” 165, which is a subclass of “Primate” 170, and witch is also a subclass of “Mammal” 175. Thus, a “Man” is a “Human” related to the “Mammal” species.

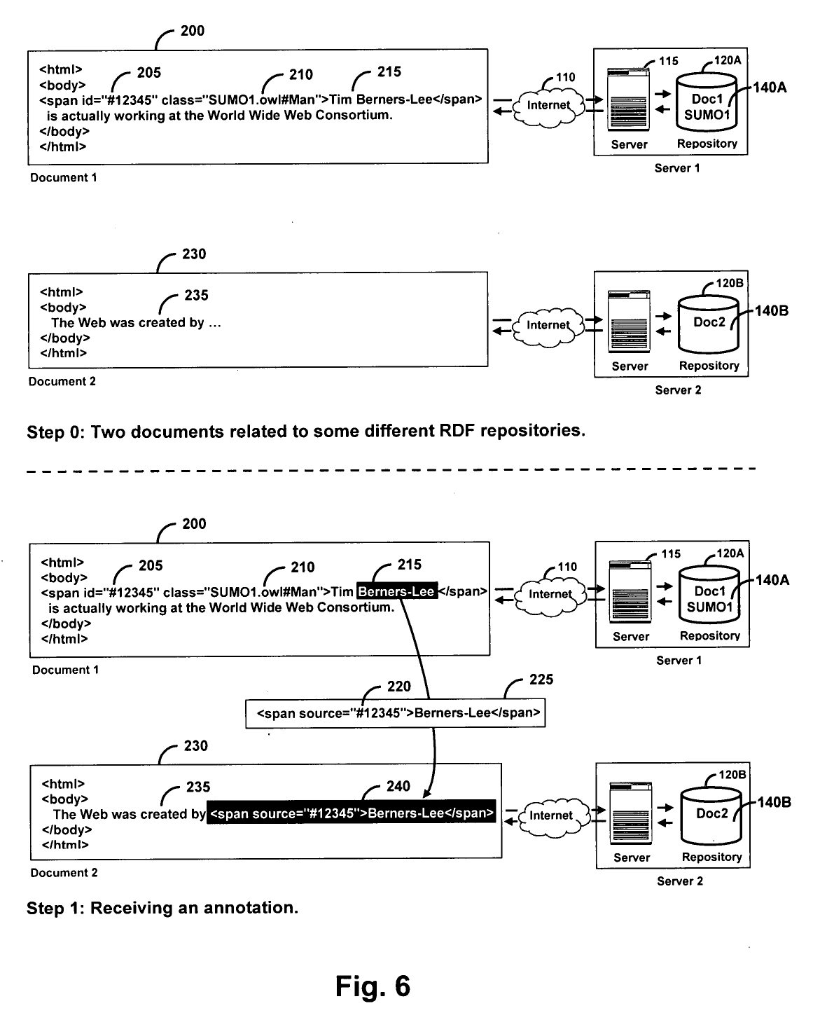

FIG. 6-7-8 graphically depict the process of enhancing a document with an annotation in order to retrieve the corresponding ontology.

FIG. 6 illustrates an exemplary embodiment of the present invention where a document 200, residing inside a client system, was downloaded from a server 115 via Internet 110. The document comprises an annotation specifying that “Tim Berners-Lee” 215 has for ID “#12345” 205 and that “Tim Berners-Lee” is related to the class “SUMO1.owl#Man” 210. In this example, the class is expressed by a relative URL that specifies that the file “SUMO1.owl” is coming from the same server as the current document. In this example, the source of the class “Man” 210 is located inside the repository 120A containing its description in a OWL format inside a RDF model space named “SUMO1”. The origin of the document 200 is also located inside the database 120A but in a different model space named “Doc1” (the presence of the different RDF model spaces is indicated by 140A).

A second document is also represented 230. This document is related to its own repository 120B and has no relation with the previous one. This document has no annotation at all 235. The origin of the document 230 is located inside the repository 120B in a RDF model space named “Doc2” 140B.

In Step 1, an annotation is exchanged between the two documents 200 and 230. This exchange can be initiated by the user or by the system. In this example, only the fragment “Berners-Lee” 215 of the original annotation is copied between the two documents. In order to transfer this annotation, the system will create a temporary annotation 225 made with the selected text fragment and the corresponding ID 220 of the source annotation 205. This temporary annotation is then incorporated inside the target document 240.

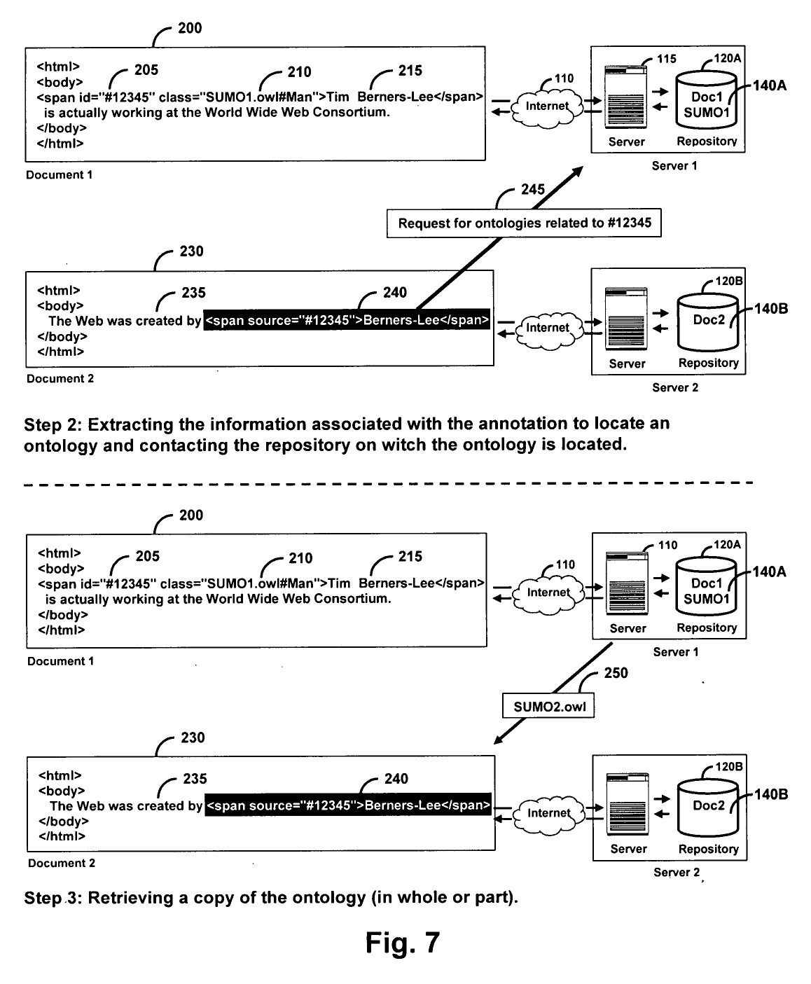

FIG. 7 illustrates the communication protocol taking place between the target document 230 and the original repository 120A. In Step 2, the source ID of the temporary annotation 240 is used to locate the origin of the ontology. A request 245 is sent to the repository in order to retrieve the ontology related to this annotation.

The mechanism to locate the physical address of the repository is explained here. In the current illustration, the source ID “#12345” 240 should be replaced by a more complex string specifying the means to access the RDF repository. The repository could take the form of a static data file (like a simple text file) or dynamic system (like a database system). In the case of simple text file, the string specifying the location of the repository could take the form of a simple URL (like “http://www.server1.com/rdf/Doc1.rdf#12345”). In a case of a dynamic system, the string specifying the location of the repository could specify the communication protocol, the server name, the database name, the RDF model name and the ID of the annotation. For example, the string “#12345” could be replaced with: “jdbc:mysql://repository.ibm.com/database3¦modelName5¦12345” where “jdbc:mysql://” represents the communication protocol to the database, “repository.ibm.com” is the server address, “database3” represents the database name, “modelName5” represents the RDF model name and “12345” the annotation ID. An encryption mechanism could eventually be applied to make this information more private. In short, the annotation ID 205 illustrated in FIG. 6-7-8 should be already build so the string “#12345” could be read as “http://www.server1.com/rdf/Doc1.rdf#12345” or “jdbc:mysql://repository.ibm.com/database3¦modelName5¦12345” in order to let the system identify the corresponding repository address of the annotation 215 in the RDF model 140A located inside the repository 120A.

In Step 2, a request 245 is sent over the Internet to retrieve the ontology (or ontologies) related to the corresponding annotation 240. Depending of the selected communication protocol, this request could take the form of a remote procedure call (RPC) or a simple formatted message like a text file. For example, if the JBDC communication protocol was specified (as “jdbc:mysql://repository.ibm.com/database3¦modelName5¦12345”), the system could establish a direct JBDC connection to the corresponding database, using for example the SPARQL protocol, to retrieve the name of the ontology related to this annotation inside the RDF model 140A. If a text protocol was specified instead, a XML message could be sent to the corresponding Web server in order to retrieve the same information in a XML format.

Step 3 illustrates a response 250 sent by the repository where the information contains a copy of the ontology related to the annotation residing inside the RDF model 140A. This copy of the ontology 250 is actually identified with a different name that the original ontology.

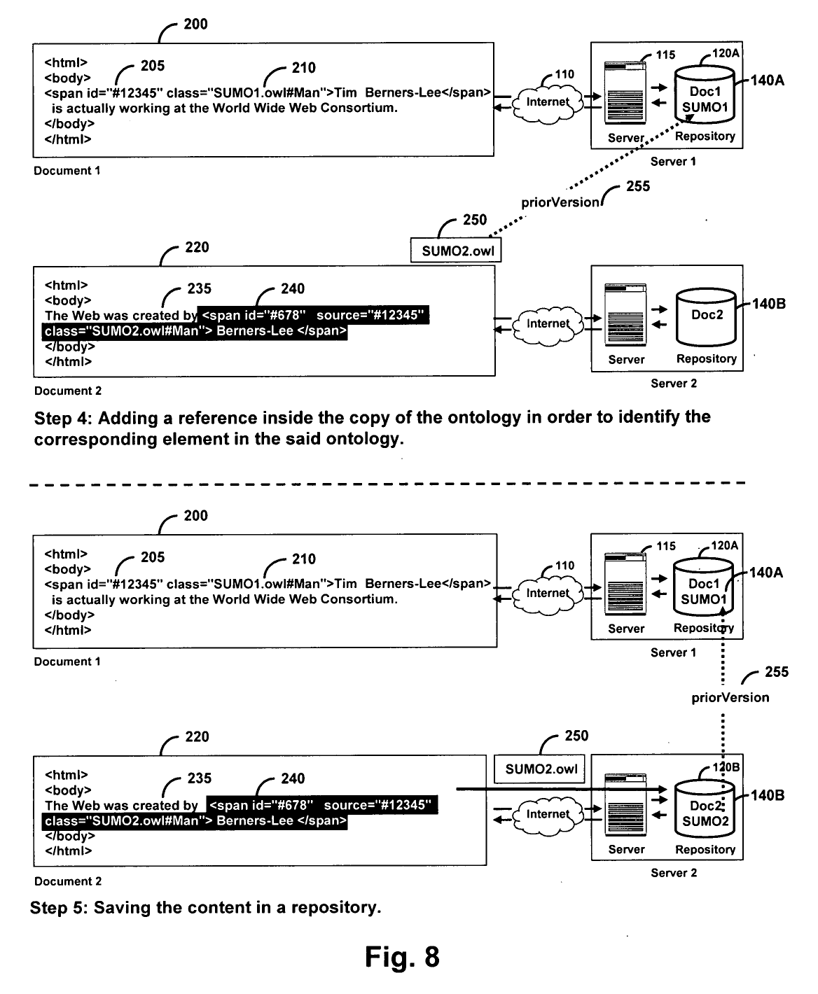

FIG. 8 illustrates the modification that takes place when receiving a response from the repository. In Step 4, a reference to the local copy of the ontology is added to the annotation 240. In the same time, a new ID reference (“#678”) is also attributed to the annotation to identify it in a unique way. This new ID is created using the same rule as before by specifying the repository address. For example, in the current illustration, the string “#678” could be replace with something like “jdbc:mysql:H/repository.sun.com/database0¦modelName2¦95” where “jdbc:mysql://” represents the communication protocol to the database, “repository.sun.com” is the server address, “database0” represents the database name, “modelName2” represents the RDF model name and “95” the annotation ID.

In step 4, a reference 255 is added to the copy of the ontology 250 in order to identify its relation to the original ontology. This reference could be expressed in the OWL syntax using the “priorVersion” attribute:

```
<rdf:Description rdf:about=“http://www.server2.com/owl/
SUMO2.owl#Man”>
  <rdf:type rdf:resource=“http://www.w3.org/2002/07/owl#Class”/>
  <rdfs:subClassOf rdf:resource=“#Hominid”/>
  <owl:priorVersion rdf:resource=“http://www.server1.com/owl/
  SUMO1.owl#Man”/>
  <owl:versionInfo>2.0</owl:versionInfo>
</rdf:Description>
```

The “priorVersion” and the “versionInfo” attributes let the system knows that the current class is related to a previous one. It also lets the system keep tracks of any changes made by different actors. This feature enables enrichment of an ontology without disrupting previous definition of the ontology.

In step 5, the document is saved inside a target repository. The copy of the ontology 250 is saved inside the repository without losing its reference 255 to the original ontology. The information saved inside the target repository can thus be used by other actors to repeat again the step 1 to 5. The step 5 is, however, not mandatory.

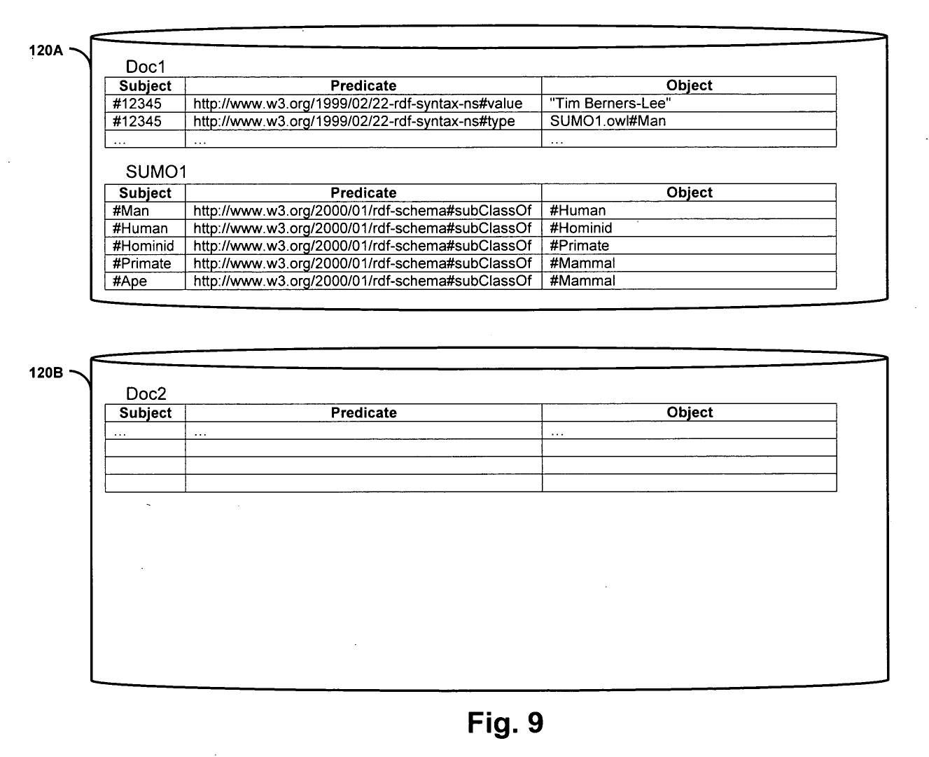

FIG. 9 illustrates the RDF model before the exchange of the annotation. The repository 120A contains the RDF model describing the document. It also contains the ontologies related to this document. This illustration of the repository corresponds to the Step 0 (FIG. 6) where no annotation has not been exchanged yet.

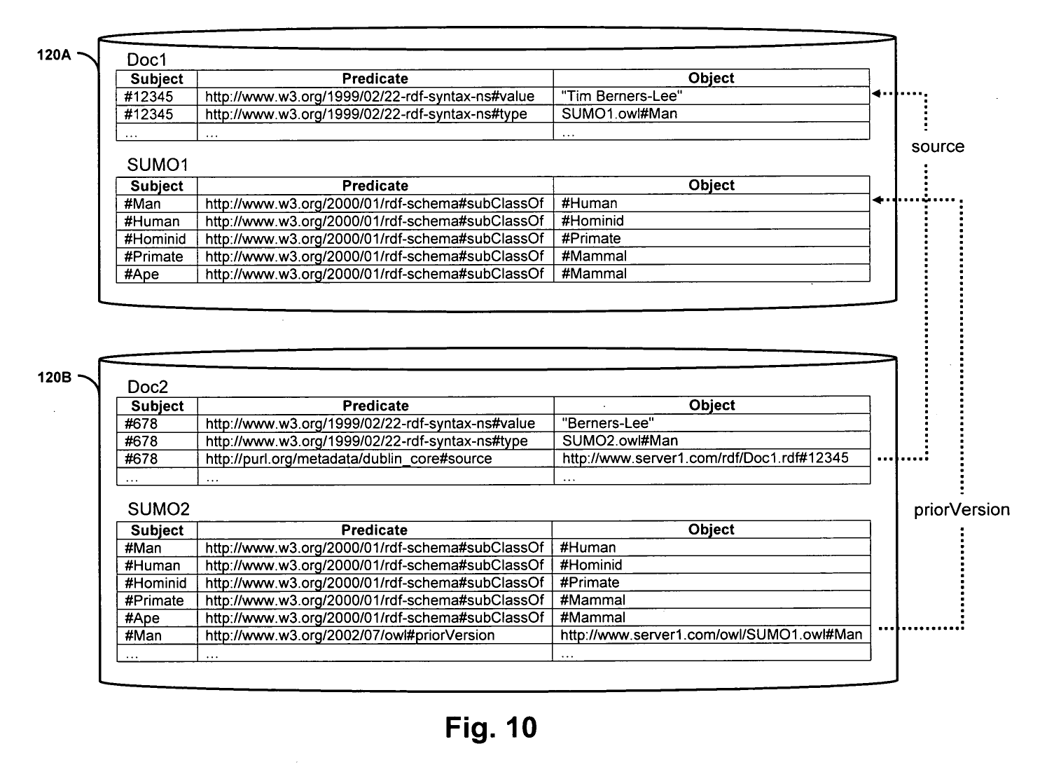

FIG. 10 illustrates the resulting RDF model after the exchange of the annotation. The repository 120B contains the new description model created after the exchange of the annotation to the second server. The model “Doc2” contains some new RDF expressions saying that the annotation “678” has for value “Berners-Lee” and that “Berners-Lee” is a sort of “Man”. The annotation “678” has its source from another annotation named “12345” located in another server (“www.server1.com/rdf/Doc1.rdf#12345”).

The model “SUMO2” contains some RDF expressions saying that a “Man” is a sort of “Human” and that the definition of “Man” is also related to a previous declaration made by another user on a different machine (“www.server1.com/owl/SUM01.owl#Man”). If we compare the declaration of SUMO1 and SUMO2, we can realize that there is an agreement in the definition of “Man” as a “Human” representing a sort of “Hominid”. Some changes could however be made to this declaration to state some different point of view by simply adding new RDF expressions to the ontology and by linking together theses expressions with some “priorVersion” references.

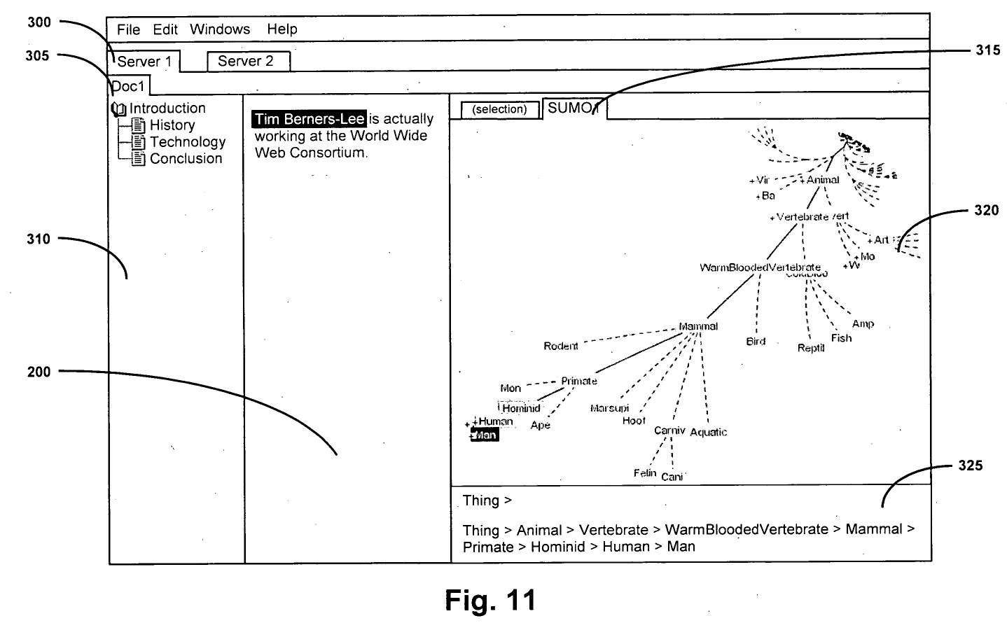

FIG. 11 presents a preferred embodiment for the graphics user interface of the client software. This interface can be use to copy annotations between different documents. FIG. 11 illustrates a user that run a program on a client machine in order to read a document located on two different servers. The tab 300 shows that the program is currently connected to “Server 1” and “Server 2”. The actual focus is on the tab “Server 1” witch contains only one document 305.

The content of the document 305 is presented in 3 different panes. The left pane 310 presents the hierarchy of the pages contained in this document. The content of each page can be view by selecting the page name inside the hierarchy list. The content of the selected page is presented in the central pane 200 (the content illustrated here also correspond to the content 200 illustrated in FIGS. 6-7-8). This content could be made of text, image, video, or any other kind of multimedia objects. Objects that are linked to an annotation are identified with a colored background. The value of the annotation can be view by placing the caret directly inside the background area. The content of annotation is then shown in the third pane 315.

The form of the third pane depends of the content of the selected annotation. It could be presented as a list of values, graphic object or other kind of visual component. In accordance with a preferred embodiment of the present invention, ontologies are presented as hyperbolic trees 320. The choice of representation is not limited to hyperbolic space and any other kind of geometric transformation could also be applied to represent ontologies. Visual components other than tree could also be used.

Each annotation can be associated with many different ontologies. In the preferred embodiment of the present invention, each ontology is however presented in a different pane 315.

An ontology can refer to many other ontologies. In the preferred embodiment of the present invention, the user can navigate iteratively from one ontology to another by clicking on a plus “+” icon representing external ontologies inside the tree structure.

In FIG. 11, the lower section 325 of the ontology pane is used to give some information about the hierarchy of the current selected ontology classes (ex: Thing>Entity>Physical> . . . ). The use of this information is not mandatory. It is simply used here as a way to compensate for the lack of space in the hyperbolic tree representation.

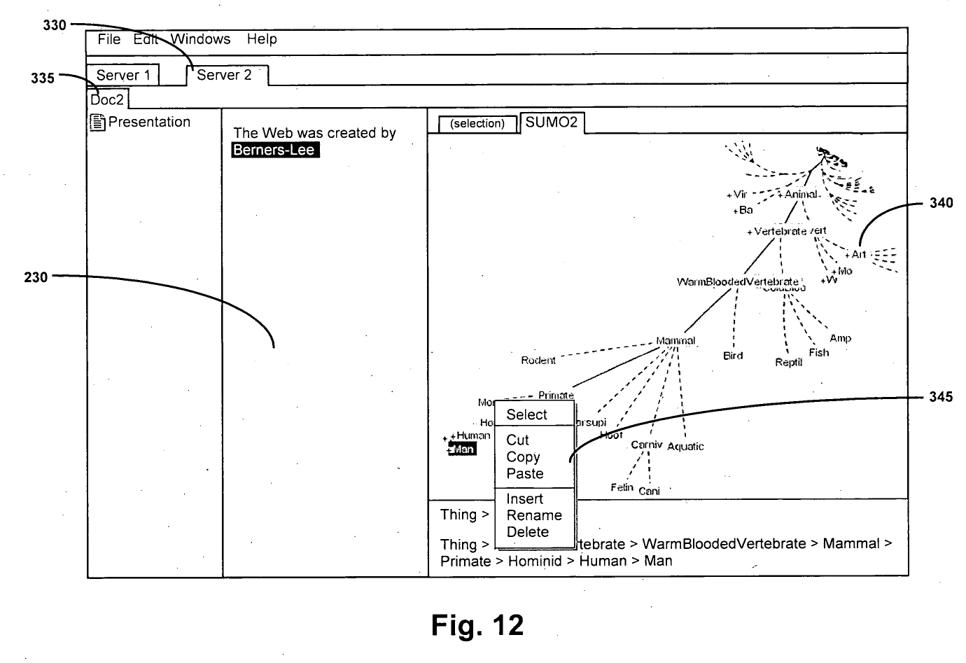

FIG. 12 illustrates the same graphics user interface, but with a different tab selected (“Server 2”) 330. It illustrates a user who has just copied and pasted an annotated text (“Berners-Lee” coming from “Doc1” in FIG. 11) in a different document (“Doc2” located in the “Server2” in FIG. 12) 335. The annotation is represented by a colored background. When moving the caret over the annotation, the ontology associated with this annotation is downloaded and copied to the server as it was explain before (FIG. 7). The newly copied ontology is represented in the ontology pane 340 in the same way as before (FIG. 11). The contextual menu 345 illustrates the possibility for the user to modify the structure of the newly downloaded ontology in order to better represent its own conception of the universe. As it was explained before, every new modification made by the user is followed by a “priorVersion” attribute that is added to the corresponding element definition in order to keep track of all changes made to the ontology.

The user can also decide to download readymade ontologies directly from the web. The user can also create a new ontology from scratch by simply starting a new tree in another ontology pane.

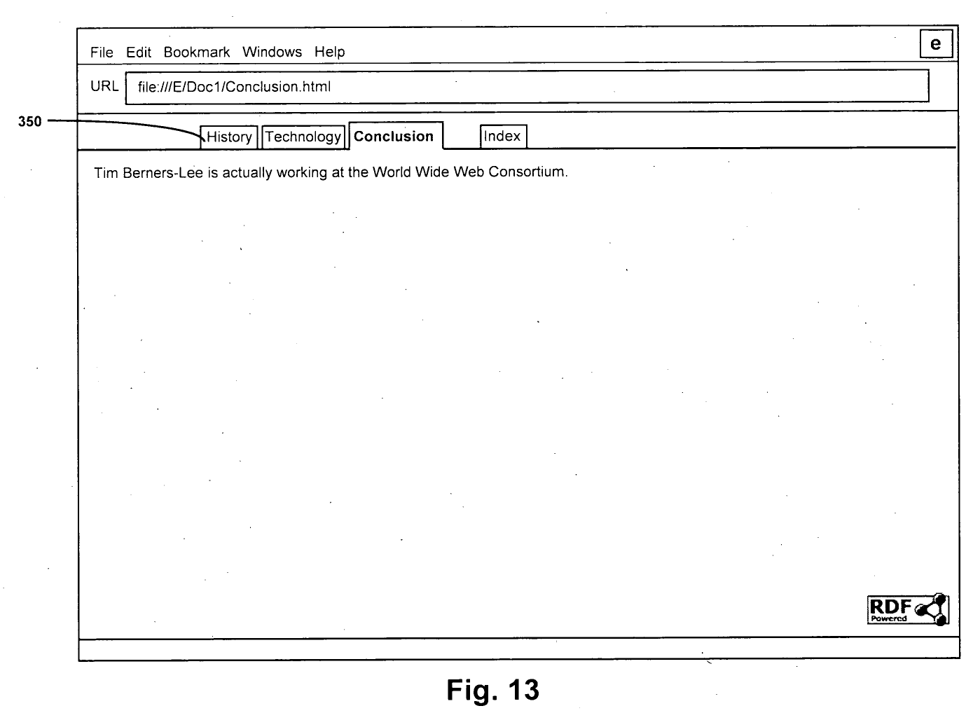

FIG. 13 presents a preferred embodiment for HTML page output. Web pages are built automatically by the system using the information contained in the selected document. For example, the illustration of FIG. 13 corresponds to the page seen previously in FIG. 11. The top of the HTML page is occupied by a menu 350 representing the hierarchy of the original document directory (FIG. 11, 310). This menu illustrates the position of the current HTML page inside the directory in a way that all pages on the same hierarchy level of the current page can be seen at the same menu level. Pages that are located in a higher or lower hierarchy position are illustrated in the corresponding location in the menu. Multi-level or cascading menu could also be used for complex situations. The menu could also be placed vertically or horizontally inside the HTML page to satisfy esthetic or ergonomic considerations. The name of the current page should however always be clearly indicated in the menu in other to give to the user a clear feedback of the current page position inside the site hierarchy.

In a preferred embodiment for HTML pages, each page is tied to some RDF descriptions that describe the content of the page. These RDF descriptions could be inserted directly into the HTML code or be placed outside in an external file. In the case of external file, a link should be inserted directly into the HTML page so that an agent could easily locate the associated RDF file. This link could be inserted into the <head> section of each HTML page. For example, the page “Conclusion.html” could be linked to a RDF file named “Conclusion.rdf” using this code:

```
<head>
  <link rel=“meta” type=“application/rdf+xml” href=“Conclusion.rdf” />
  ...
</head>
```

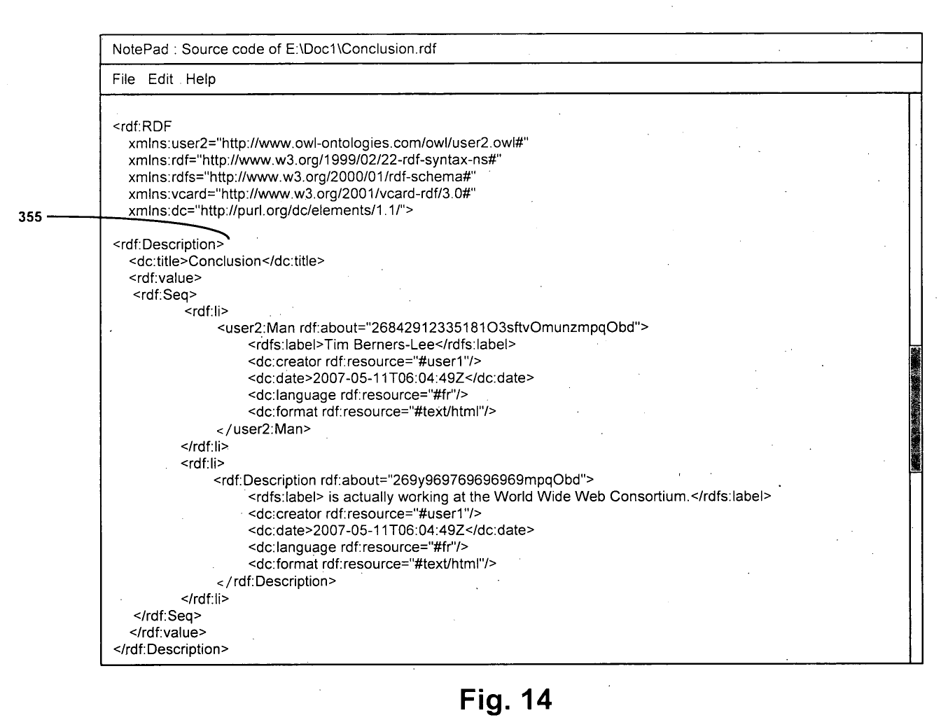

FIG. 14 illustrates the content of a RDF description file named “Conclusion.rdf” that describes the content of the web page named “Conclusion.html” (already presented in FIG. 13). The RDF descriptions 355 are produced in order to let software agents to access the semantic value of Web contents. For example, the description of FIG. 14 stipulates that “Tim Berners-Lee” is a “Man” and this concept of “Man” is related to a specific ontology. This description was created on a specific date by a user named “user1”. The presence of a “source” attribute stipulate that the “user1” has copied this text from another user named “user2”. Using the reference to “Man”, an agent could locate the “priorVersion” attribute to identify different ontologies related to the same concept as this one. The agent could also use the same strategy to locate all contents related to this concept by locating all web contents that are using the same reference to “Man” (or other reference to any “priorVersion” attribute related to “Man”). Other uses are also possible for RDF description like semantic search, semantic profiling, semantic advertising, semantic browsing and querying.

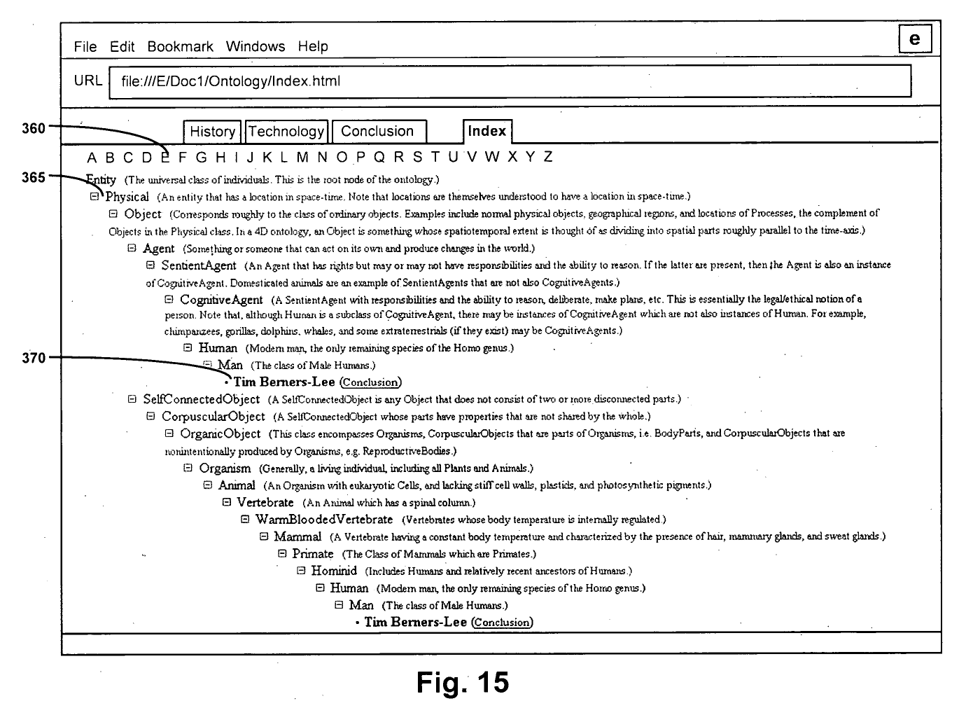

FIG. 15 illustrates a preferred embodiment for an HTML index created by the system to resume the entire web site. This index takes the form of a hierarchy of concepts 365 enumerating the position of each concept inside the web site. The index is constructed automatically by the client software using ontologies classes that are linked to annotations and by enumerating all web pages where these annotations take place. The ontology classes are represented in sorted order, from the most general concept down to the particular one in the form of a hierarchy list. If a description is available, this information is then shown next to the class. The lower end of each branch presents the words 370 related to the annotation and a link (or links) to the page where this annotation is located. The index page has also an alphabetical menu 360 that gives access to ontology classes using the first letter of their name.

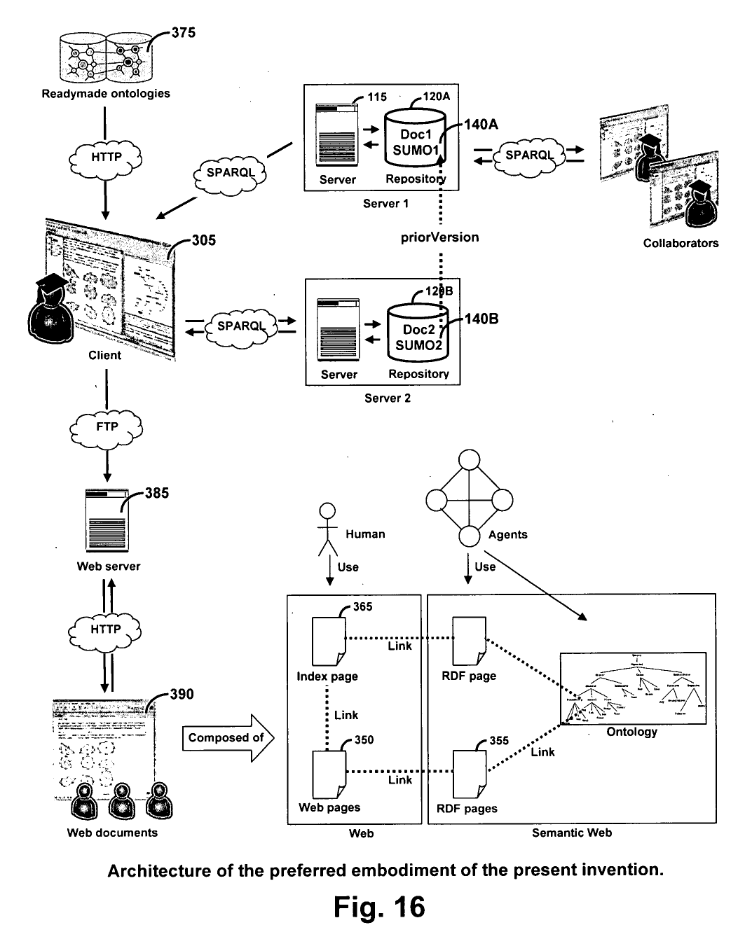

FIG. 16 illustrates the architecture of the preferred embodiment of the present invention. The application 305, running as a client software, is connected to a distant repository 120B containing the RDF models 140B. This client application can also be connected to one 120A or many other repositories in order to let the user copy and paste contents in different documents. As it was explained before, the main goal of this application is to exploit annotations in order to create indirect links between ontologies. If an annotation is moved between two different documents and this annotation is already containing a reference to an ontology class, then this information is used by the system to make a local copy of the ontology and to create an indirect link (“priorVersion”) between the new ontology elements and their original counterparts (as shown before in FIG. 10). The indirect links created between different ontology classes constitute a global ontology that can be used afterward by search engines to locate the Web contents. As it was explained before, the communication protocol between the client software and the repository can take many different forms. In the preferred embodiment, the communication protocol takes the form of remote procedure call (RPC) using SPARQL on top of JBDC to access a SQL database.

Using the convenience of the graphic user interface, the user can choose to create its own ontology classes or download readymade ontologies 375 before modifying them for its own use. Readymade ontologies can simply be downloaded with a FTP or HTTP protocol using some web services like Google (http://www.google.com), Swoogle (http://swoogle.umbc.edu) or Ontaria (http://www.w3.org/2004/ontaria/).

The client application supports the creation of documents for the Web by converting the contents coming from the repository in HTML format. The client application also supports the utilization of these documents in the Semantic Web by adding some RDF descriptions to every document being produced (as it was shown before in FIG. 14). The documents and the RDF descriptions can be transferred on a web server 385 by means of FTP or other protocol. These documents are accessed in a normal way by web users using a web browser 390. The web users can navigate between the different web pages 350 using the navigation menu located at the top of all pages produced by the client system (as shown before in FIG. 13). The web users can also access an index page 365 in order to find contents related to some specific concept (as shown before in FIG. 15). The web pages, as well as the index pages, have a distinct RDF descriptions file 355 that can be used by agents or search engines to locate concepts or ontology classes used in those pages. Ontologies can thus be used by software agents has the main entry point to start their search.

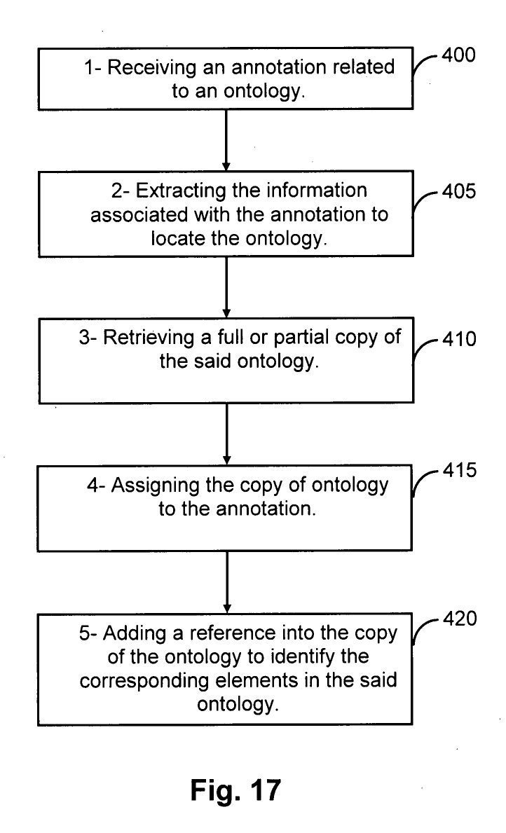

FIG. 17 resumes graphically the process of using annotations as means of ontology modeling. The process is presented in 5 steps resuming the illustrations of FIGS. 6-7-8:
1—Receiving an annotation related to an ontology;
2—Extracting the information associated with the annotation in order to locate the said ontology;
3—Retrieving a full or partial copy of the said ontology;
4—Assigning the copy of ontology to the annotation;
5—Adding a reference inside the copy of ontology in order to identify the corresponding elements in the said ontology.

One of ordinary skill in the art would recognize that modifications and extensions may be made which are within the scope of the present invention. For example, the process of producing documents can be separate from the client software and be executed by a different application running on a different machine. The process of retrieving a copy of an ontology can be modified to suit the need of a peer to peer network or an integrated system working with or without any socket.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such as floppy disc, a hard disk drive, RAM, and CD-ROM's, as well as transmission-type media, such as digital and analog communications links.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

1- A method for ontology modeling comprising the step of:
a. receiving an annotation related to an ontology;
b. extracting the information associated with the said annotation in order to locate the said ontology;
c. retrieving a full or partial copy of the said ontology;
d. assigning the said copy of ontology to the said annotation;
e. adding a reference inside the said copy of ontology in order to identify the corresponding elements in the said ontology;

2- The method of claim 1, wherein said repository includes at least one of the following:
a. a database;
b. a file;
c. a record set;
d. a record;
e. a memory location.

3- The method of claim 1, wherein the said annotation comprises the description of contents select from the group consisting of data, data sets, text, semi-structured text, image, audio, video, animations, multimedia content, digital media content including TV and radio content potentially delivered on Internet.

4- The method of claim 1, wherein the step of extracting the information comprises the step of identifying at least one of the following:
a. the communication protocol;
b. the server address;
c. the repository address;
d. the file address;
e. the RDF model name;
f. the resource name.

5- The method of claim 1, wherein the step of retrieving a full or partial copy of the said ontology comprises the utilization of a socket connection.

6- The method of claim 1, further comprising the step of generating a document.

7- The method of claim 6, wherein said document includes at least one of the following:
a. a web page;
b. an image;
c. a text document;
d. a video;
e. a multimedia document;
f. a XML document;
g. a semantic web document;
h. a data.

8- The method of claim 6, wherein said document includes an index to link some elements of the said copy or said ontology to the said annotation.

9- The method of claim 6, wherein said document includes semantic descriptions using the said copy or the said ontology.

10- The method of claim 1, further comprising the step of modifying the said copy by merging ontology parts manually, semi-manually or automatically by means of possible guidance rules.

11- The method of claim 10, wherein the step of modifying the said copy comprises the step of:
a. displaying some ontology elements visually;
b. applying a geometric projection or a visual transformation to the representation of the said elements.

12- The method of claim 1, further comprising the step of saving the said annotation or the said copy to a target repository.

13- A distributed ontology system for modeling ontologies comprising:
a. a multitude of repositories, comprising a multitude of contents with a multitude of annotations related to a multitude of ontologies;
b. a multitude of repositories, comprising a multitude of ontologies;
c. a system for copying an annotation, comprising:
i. a transfer system to recover an annotation from the said repositories;
ii. a system for making a copy element of the ontologies related to the said annotation;
iii. a system for assigning the said copy element to the said annotation;
iv. a system for creating a multitude of links between the said copy element of ontologies and the said ontologies themselves in order to identify the correspondence between them.

14- The system of claim 13, wherein said repositories include at least one of the following:
a. a database;
b. a file;
c. a record set;
d. a record;
e. a memory location.

15- The system of claim 13, wherein the said annotation comprises the description of contents select from the group consisting of data, data sets, text, semi-structured text, image, audio, video, animations, multimedia content, digital media content including TV and radio content potentially delivered on Internet.

16- The system of claim 13, wherein the system for making a copy element of the ontologies comprises a system for identifying at least one of the following:
a. the communication protocol;
b. the server address;
c. the repository address;
d. the file address;
e. the RDF model name;
f. the resource name.

17- The system of claim 13, wherein the system for making a copy element of the ontologies comprises the utilization of a socket connection.

18- The system of claim 13, further comprising a system for generating a document.

19- The system of claim 18, wherein said document includes at least one of the following:
a. a web page;
b. an image;
c. a text document;
d. a video;
e. a multimedia document;
f. a XML document;
g. a semantic web document;
h. a data.

20- The system of claim 18, wherein said document includes an index to link some elements of the said copy or said ontologies to the said annotation.

21- The system of claim 18, wherein said document includes semantic descriptions using the said copy or the said ontologies.

22- The system of claim 18, further comprising a system for modifying the said copy by merging ontology parts manually, semi-manually or automatically by means of possible guidance rules.

23- The system of claim 22, wherein the system for modifying the said copy comprises a system for:
a. displaying some ontology elements visually;
b. applying a geometric projection or a visual transformation to the representation of the said elements.

24- The system of claim 13, further comprising the system for saving the said annotation or the said copy element to a target repository.
